(19) United States
(12) Patent Application Publication
(10) Pub. No.: US 2017/0328539 A1
(43) Pub. Date: Nov. 16, 2017

(54) COLOR CONVERSION FILM AND PLANE LIGHT SOURCE USING THE SAME

(71) Applicant: Coretronic Corporation, Hsin-Chu (TW)

(72) Inventor: Yu-An Huang, Hsin-Chu (TW)

(21) Appl. No.: 15/499,627

(22) Filed: Apr. 27, 2017

(30) Foreign Application Priority Data
May 13, 2016 (CN) 201620435595.8

(51) Int. Cl. F21V 9/16; F21V 8/00

(52) U.S. Cl. CPC F21V 9/16; G02B 6/005

(57) ABSTRACT

A color conversion film includes a silicon substrate, and several first quantum dots and second quantum dots dispersed within the silicon substrate, wherein each of the first quantum dots includes silicone amine polymer and red quantum dots, and each of the second quantum dots includes silicone amine polymer and green quantum dots. A plane light source including the color conversion film is provided.

### CROSS-REFERENCE TO RELATED APPLICATION

THIS APPLICATION CLAIMS THE PRIORITY BENEFIT OF CHINESE APPLICATION SERIAL NO. 201620435595.8, FILED ON MAY 13, 2016. THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a color conversion film for a light source and light source using the same, and more particularly to a color conversion film converting blue light into wide color gamut light by quantum dots and a plane light source using the same.

### BACKGROUND OF THE INVENTION

Existing wide gamut color conversion films are excited by blue light (wavelength 450 nm) as the light source to stimulate the films composed by the green and red light-emitting materials. Existing commercial products, such as 3M/Nanosys's quantum dots enhanced film (QDEF), are wide gamut color conversion films composed by red and green quantum dots, or PhosphorTech company's RadiantFex, are wide gamut color correction films composed by yellow and red phosphor. However, the existing QDEF substrate materials are epoxy resins or acrylic resins, and an epoxy resin or an acrylic resin used in the color conversion film bears the problems of being unstable and easily being turned yellow under light emitting. Based on the above issues, there is still great room for improving technology and related applications for the device utilizes quantum dots to convert blue light to a wide gamut of colors.

The information disclosed in this “BACKGROUND OF THE INVENTION” Section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

In order to achieve one or a portion of or all of the objects or other objects, an embodiment of the invention provides a color conversion film includes a silicon substrate, and several first quantum dots and second quantum dots dispersed within the silicon substrate, wherein each of the first quantum dots includes silicone amine polymer and red quantum dots, and each of the second quantum dots includes silicone amine polymer and green quantum dots.

The invention further provides a plane light source, which includes at least one blue light emitting element; and a color conversion film disposed beside the at least one blue light emitting element for receiving a blue light stream emitted from the at least one blue light emitting element, wherein the color conversion film includes a silicon substrate; and an certain amount of first quantum dots and second quantum dots dispersed within the silicon substrate, wherein each of the first quantum dots includes silicone amine polymer and a first quantum dot, and each of the second quantum dots includes silicone amine polymer and a second quantum dot.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The invention will become more readily apparent to those ordinarily skilled in the art after reviewing the following detailed description and accompanying drawings, in which:

FIG. 1 is a schematic cross-sectional view illustrating an operation of a color conversion film in accordance with an embodiment of the invention.

FIG. 2 is a schematic cross-sectional view of a plane light source in accordance with an embodiment of the invention.

FIG. 3 is a schematic cross-sectional view illustrating an operation of a plane light source in accordance with another embodiment of the invention.

FIG. 4 is a diagram illustrating variations of the silicone substrate color conversion film brightness and white point under different ratios of red and green in accordance with an embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

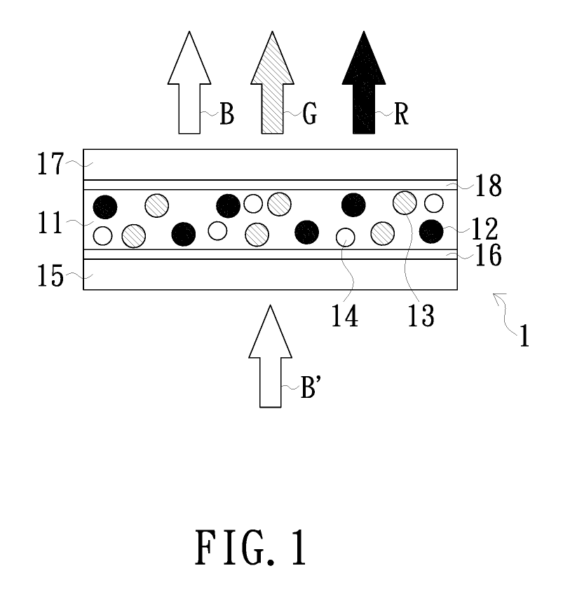

FIG. 1 is a schematic cross-sectional view illustrating an operation of a color conversion film in accordance with an embodiment of the invention. The color conversion film 1 includes silicon substrate 11 and first quantum dots 12 and second quantum dots 13. The first quantum dots 12 and second quantum dots 13 are dispersed within the silicon substrate 11. Each of the first quantum dots 12 includes silicone amine polymer and first quantum dot, e.g. red quantum dots. Each of the second quantum dots 13 includes silicone amine polymer and second quantum dot, e.g. green quantum dot.

In the past quantum dot applications, due to an appropriate ligand has not yet appeared enabling quantum dots to be dispersed in the silicone, so the traditional QDEF has not yet appeared with silicone as the substrate. The invention is to solve the problem of the dispersion of the quantum dots in silicone, and thus quantum dot enhancement films with better characteristics than conventional QDEF may be obtained.

In order to achieve the effect of light diffusion through light reflection, the color conversion film further includes many light scattering transparent particles 14 dispersed within the silicon substrate 11. The light scattering transparent particles 14 may be made of, e.g., aluminum oxide, titanium dioxide, silicon dioxide, or other suitable compounds.

Please refer to FIG. 1 again, barrier layers 16, 18 sandwich the silicon substrate 11 to block the moisture or air in the atmosphere. The barrier layers 16, 18 may be made of aluminum oxide, titanium dioxide, silicon dioxide, or other suitable compounds. The surfaces of the barrier layers backward to the surfaces of the silicon substrates 11 may be selectively attached with the first substrate 15 and the second substrate 17 opposite to the first substrate 15 for increasing the mechanical strength of the color conversion film 1 to satisfy needs of practical applications. The first substrate 15 and the second substrate 17 may be made of polyethylene terephthalate (PET) or other similar material. In other embodiments, the PET material of the first substrate 15 and the second substrate 17 may serve as the barrier layers for isolating the gas (the moisture or air). That is, in these embodiments, the barrier layers 16, 18 may be selectively omitted, and the first substrate 15 and the second substrate 17 may be attached to the surfaces of the silicon substrate 11 for cost saving in material.

When utilizing the color conversion film 1 of this embodiment, as shown in FIG. 1, one side of the color conversion film 1 is illuminated by the blue light B′, wherein portions of the blue light B′ are converted by the first quantum dots 12 and the second quantum dots 12 into red light R and green light G, and the non-converted portion of the blue light B′ forms the blue light B through the color conversion film 1. Accordingly, the blue light B′ is converted by the color conversion film 1 into beams containing three-primary colors: red light R, green light G, and blue light B, and thus achieve the color conversion of wide-color gamut.

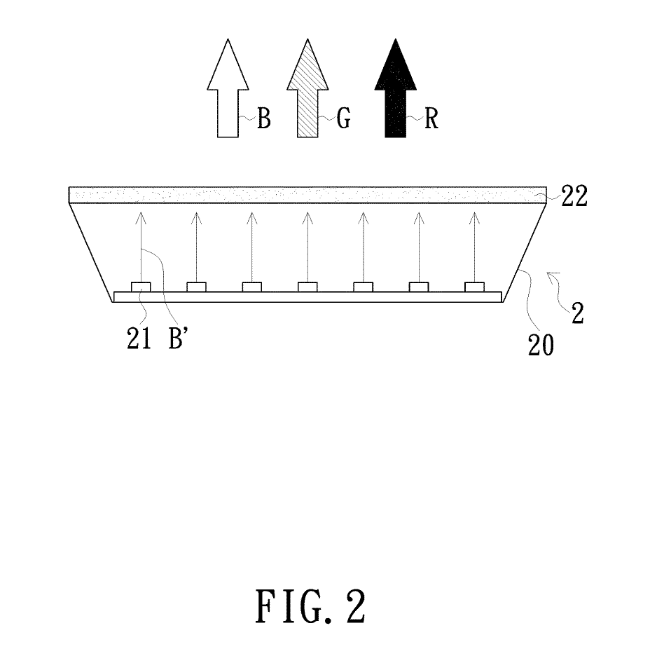

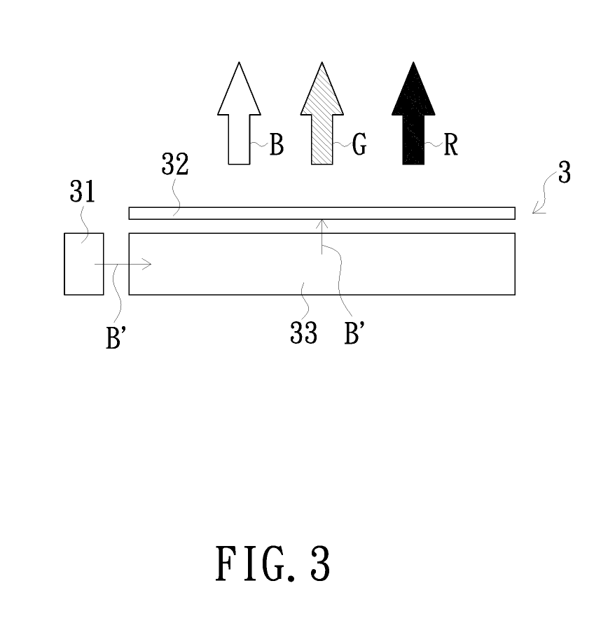

The color conversion film 1 according to the invention may be applied to various plane light sources, e.g. a backlight module using blue light emitting diode (LED) to enhance the effect of the color gamut. As shown in FIG. 2, the plane light source 2 includes a backplane 20, a blue light emitting element 21 disposed on the backplane 20, and a color conversion film 22 practically the same as the color conversion film 1. The blue light emitting element 21 may be, e.g., LEDs, laser diodes, cold cathode fluorescent lamps or other suitable light-emitting element capable of emitting blue light B′ (a blue LED strip disposed on the backplane 21 is illustrated in FIG. 2, but is not to limit the scope of the invention), and the color conversion film 22 is disposed beside the blue light emitting element 21 for receiving and converting the blue light B′ emitted from the blue light emitting element 21. As shown in FIG. 3, the plane light source 3 includes the blue light emitting element 31, the color conversion film 32 practically the same as the color conversion film 1, and the light guide 33. The light guide 33 is disposed beside the blue light emitting element 31 for receiving the blue light B′ (as the arrow pointing to the right direction illustrated in FIG. 3) emitted from the blue light emitting elements, and guide the blue light B′ into the color conversion film 32 to be converted.

The invention further provides a method for manufacturing the color conversion film 1. An embodiment of the method is as below. Please refer to FIG. 1. First of all, the first quantum dot and the second quantum dot (e.g. red quantum dot and green quantum dot) are respectively mixed with silicone amine polymer in a weight percentage of about, e.g. 10%, for forming first quantum dots 12 and second quantum dots 13. The first quantum dots 12 and the second quantum dots 13 then are mixed into a room temperature vulcanization (RTV) silicon. Finally, the light scattering transparent particles 14 are dispersed into the RTV silicon for forming row-material layer of the silicon substrate 11. The aforementioned barrier layers, substrates, and so on, are then applied through the roll-to-roll technique to the above-mentioned row-material layer of the silicon substrate 11, and the RTV silicon (silicon substrate 11) is then vulcanized to form the color conversion film 1 (or 22, or 32). The weight of the first quantum dot and the second quantum dot is 1%˜6%, more preferably 3.5%˜4.5%, of a total weight of the color conversion film 1 (or 22, or 32). Wherein, the weight ratio between the first quantum dot and the second quantum dot is about 1:17˜1:49. Furthermore, the weight of the light scattering transparent particles 14 is, e.g., 10%˜35% of a total weight of the silicon substrate 11. The scope of the invention is not limited to the above-mentioned embodiments.

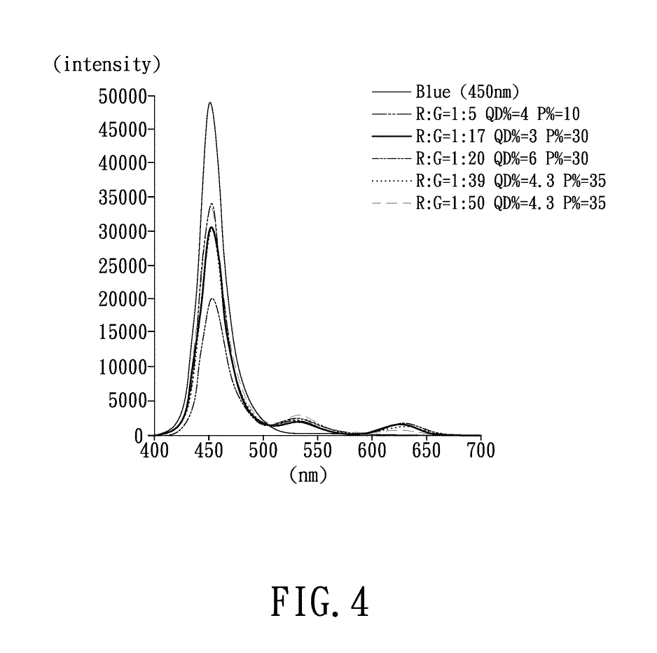

FIG. 4 and the following test experimental data in Table 1 show the variation of brightness and white point of the silicone substrates of the color conversion films according to the invention under different ratios of red and green phosphor, wherein the silicone substrate for testing has a thickness of 100 μm, the vertical axis represents the intensity of light (in intensity), the horizontal axis represents the wavelength (in nm). In FIG. 4 and the following Table 1, values of x, y represent the coordinate of the CIE color space chromaticity diagram, L is the luminance (in nits), R: G refers to weight ratio between the red quantum dots and the green quantum dots, QD % refers to the weight percentage of the quantum dot in the silicon substrate, P % refers to the weight percentage of the light scattering transparent particle in the silicone substrate. Furthermore, the curve labeled with Blue (450 nm) illustrated in FIG. 4 represents the portion of the blue light which is not converted in wavelength by the color conversion film. The test results indicate that when there is 0.1% to 10% of the total quantum dot, different ratios between the red quantum dot and the green quantum dot may appropriately adjust the brightness and the desired white point.

TABLE 1

| Blue BLU | x | y | L (nits) |
|---|---|---|---|
| R:G = 1:5 QD % = 4 P % = 10 | 0.256 | 0.174 | 2950 |
| R:G = 1:17 QD % = 3 | 0.255 | 0.213 | 3170 |
| P % = 30 | | | |
| R:G = 1:20 QD % = 6 | 0.339 | 0.269 | 2450 |
| P % = 30 | | | |
| R:G = 1:39 QD % = 4.3 | 0.245 | 0.263 | 5390 |
| P % = 35 | | | |
| R:G = 1:50 QD % = 4.3 | 0.243 | 0.254 | 5080 |
| P % = 35 | | | |

In summary, in the invention, red and green quantum dots are mixed with silicon amine polymer, whereby the quantum dots are capable of being dispersed within a silicon substrate, and the problems in the conventional art, such as epoxy resin and acrylic resin substrates are unstable in the conversion film and are easily turned to yellow under light emitting, are solved. And the stable characteristics of silicone substrate enable the quantum dot technology to be more widely used in related industries. The test result shows that, utilizing the wide color gamut conversion film of the invention in blue light-emitting diode backlight module may increase the panel's gamut from NTSC72% (performed by NYAG phosphor) to REC2020 80%.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A color conversion film comprising:
a silicon substrate;
a plurality of first quantum dots dispersed within the silicon substrate; and
a plurality of second quantum dots dispersed within the silicon substrate, wherein each of the first quantum dots includes silicone amine polymer and a red quantum dot, and each of the second quantum dots includes silicone amine polymer and a green quantum dot.

2. The color conversion film of claim 1, further comprising a plurality of light scattering transparent particles dispersed within the silicon substrate.

3. The color conversion film of claim 1, further comprising a first substrate disposed a surface of the silicon substrate.

4. The color conversion film of claim 3, further comprising a barrier layer disposed between the first substrate and the silicon substrate.

5. The color conversion film of claim 3, further comprising a second substrate disposed the other surface of the silicon substrate, wherein the second substrate is opposite to the first substrate.

6. The color conversion film of claim 5, wherein a barrier layer disposed between the second substrate and the silicon substrate.

7. A plane light source, comprising:
at least one blue light emitting element; and
a color conversion film disposed beside the at least one blue light emitting element for receiving at least one blue light emitted from the at least one blue light emitting element, wherein the color conversion film comprises:
a silicon substrate;
a plurality of first quantum dots dispersed within the silicon substrate; and
a plurality of second quantum dots dispersed within the silicon substrate, wherein each of the first quantum dots includes silicone amine polymer and a red quantum dot, and each of the second quantum dots includes silicone amine polymer and a green quantum dot.
